(19) United States
(12) Patent Application Publication
(10) Pub. No.: US 2003/0103880 A1
(43) Pub. Date: Jun. 5, 2003

(54) Fuel processor utilizing heat pipe cooling

(76) Inventors: Kenneth J. Bunk, Millersville, MD (US); Robert A. Childress, Forest Hill, MD (US); Michael Fafaul, Sparus, MD (US); John R. Farrell, Reisterstown, MD (US); Curtis L. Krause, Houston, TX (US); Wendell B. Leimbach, Baltimore, MD (US); James W. Marshall, Phoenix, MD (US); Dennis C. Nagle, Ellicott City, MD (US); James F. Stevens, Katy, TX (US); Rick Wallace, Perry Hall, MD (US)

Correspondence Address: STEPHEN H. CAGLE, HOWREY, SIMON, ARNOLD & WHITE, LLP, 750 BERING DRIVE, HOUSTON, TX, 77057, US

(21) Appl. No.: 10/217,080

(22) Filed: Aug. 12, 2002

Related U.S. Application Data
(60) Provisional application No. 60/311,459, filed on Aug. 10, 2001.

(51) Int. Cl. B01J 8/02

(52) U.S. Cl. 422/211; 422/190; 422/198; 422/177; 422/109

(57) ABSTRACT

An apparatus for carrying out a process of converting hydrocarbon fuel to a hydrogen rich gas utilizes heat pipes to control the temperatures of the reactor beds, manage heat and integrate the heat management in a simple and efficient manner.

Priority of U.S. Provisional Application No. 60/311,459, filed Aug. 11, 2001, the contents of which are incorporated by reference, is claimed.

### BACKGROUND OF THE INVENTION

Fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is proportional to the consumption rate of the reactants.

A significant disadvantage which inhibits the wider use of fuel cells is the lack of a widespread hydrogen infrastructure. Hydrogen has a relatively low volumetric energy density and is more difficult to store and transport than the hydrocarbon fuels currently used in most power generation systems. One way to overcome this difficulty is the use of reformers to convert the hydrocarbons to a hydrogen rich gas stream which can be used as a feed for fuel cells.

Hydrocarbon-based fuels, such as natural gas, LPG, gasoline, and diesel, require conversion processes to be used as fuel sources for most fuel cells. Current art uses multi-step processes combining an initial conversion process with several clean-up processes. The initial process is most often steam reforming (SMR), autothermal reforming (ATR), catalytic partial oxidation (CPOX), or non-catalytic partial oxidation (POX). The clean-up processes are usually comprised of a combination of desulfurization, high temperature water-gas shift, low temperature water-gas shift, selective CO oxidation, or selective CO methanation. Alternative processes include hydrogen selective membrane reactors and filters.

Despite the above work, there remains a need for a simple unit for converting a hydrocarbon fuel to a hydrogen rich gas stream for use in conjunction with a fuel cell.

### SUMMARY OF THE INVENTION

The present invention is generally directed to an apparatus for converting hydrocarbon fuel into a hydrogen rich gas that includes: a hydrocarbon reforming reactor; a water gas shift reactor; and a selective oxidation reactor which in cooperative relationship produce the hydrogen rich gas wherein the temperatures of the reactor beds are regulated by the use of heat pipes.

In one such illustrative embodiment, the hydrocarbon reforming reactor includes a catalyst for reacting a fuel mixture under reforming conditions to give a hydrogen containing gaseous mixture. The catalyst may be either an auto-thermal reformation catalyst, a steam reforming catalyst or a combination of these. The water gas shift reactor includes a catalyst for reacting the hydrogen containing gaseous mixture under water gas shift reaction conditions to give an intermediate hydrogen containing gaseous mixture with a substantially reduced carbon monoxide content. The including selective oxidation reactor includes a catalyst for reacting the intermediate hydrogen containing gaseous mixture under selective oxidation reaction conditions to produce a hydrogen rich gas. In one illustrative embodiment, a heat pipe is utilized to transmit the heat generated in the selective oxidation reactor to pre-heat the hydrocarbon fuel into a heated hydrocarbon fuel, wherein the heated hydrocarbon fuel becomes the hydrocarbon fuel feed to the hydrocarbon reforming reactor. The heat source for the reforming reaction heat pipe may preferably be an anode tail gas oxidizer for a fuel cell. The design and selection of the heat pipes utilized in the present invention may include a simple heat pipe; variable conductance heat pipe or a self-regulating variable conductance heat pipe or combinations of these.

### BRIEF DESCRIPTION OF THE DRAWINGS

The description is presented with reference to the accompanying drawings in which:

FIG. 1 depicts a simple process flow diagram for one illustrative embodiment of the present invention.

FIG. 2 depicts a simple heat pipe as may be utilized in the illustrative embodiments of the present invention.

FIG. 3 depicts a variable conductance heat pipe as may be utilized in the illustrative embodiments of the present invention.

FIG. 4 depicts a self-regulating variable conductance heat pipe as may be utilized in the illustrative embodiments of the present invention.

FIG. 5 depicts in a cross-sectional top view a heat pipe as may be utilized in the illustrative embodiments of the present invention.

FIG. 6 depicts in a cross-sectional side view of the use of heat pipes in the integration of heat management within a fuel reformer as may be utilized in the illustrative embodiments of the present invention.

FIG. 7 depicts in a cross-sectional top view a heat pipe having fins as may be utilized in the illustrative embodiments of the present invention.

FIG. 8 depicts in a cross-sectional side view of the use of heat pipes in the integration of heat management within a fuel reformer as may be utilized in the illustrative embodiments of the present invention.

### DESCRIPTION OF ILLUSTRATIVE EMBODIMENTS

The present invention is generally directed to apparatus for converting hydrocarbon fuel into a hydrogen rich gas in which the temperature of the differing reaction stages are regulated by the use of heat pipes. In a preferred aspect, the apparatus and method described herein relate to a compact processor for producing a hydrogen rich gas stream from a hydrocarbon fuel for use in fuel cells in which reaction temperatures and heat integration is achieved by use of heat pipes. However, other possible uses are contemplated for the apparatus and method described herein, including any use wherein a hydrogen rich stream is desired. Accordingly, while the invention is described herein as being used in conjunction with a fuel cell, the scope of the invention is not limited to such use.

The reactor feed includes a hydrocarbon, oxygen, and water. The oxygen can be in the form of air, enriched air, or substantially pure oxygen. The water can be introduced as a liquid or vapor. The composition percentages of the feed components are determined by the desired operating conditions, as discussed below.

The hydrocarbon fuel may be liquid or gas at ambient conditions as long as it can be vaporized. As used herein the term “hydrocarbon” includes organic compounds having C—H bonds, which are capable of producing hydrogen from a partial oxidation or steam reforming reaction. The presence of atoms other than carbon and hydrogen in the molecular structure of the compound is not excluded. Thus, suitable fuels for use in the method and apparatus disclosed herein include (but are not limited to) not only such fuels as natural gas, methane, ethane, propane, butane, naphtha, gasoline and diesel fuel, but also alcohols such as methanol, ethanol, propanol, and the like.

The effluent stream exiting the fuel processors of the present invention includes synthesis gas (hydrogen and carbon monoxide) and can also include some water, carbon dioxide, unconverted hydrocarbons, impurities (e.g., hydrogen sulfide) and inert components (e.g., nitrogen and argon, especially if air was a component of the feed stream).

The reactors and structures disclosed herein can be fabricated from any material capable of withstanding the operating conditions and chemical environment of the reactions described herein and can include, for example, stainless steel, Inconel, Incoloy, Hastelloy, and the like. The reaction pressure is preferable from about 0 to about 100 psig, although higher pressures may be employed. The operating pressure of the reactor depends upon the delivery pressure required by the fuel cell. For fuel cells operating in the 1 to 20 kW range an operating pressure of 0 to about 100 psig is generally sufficient.

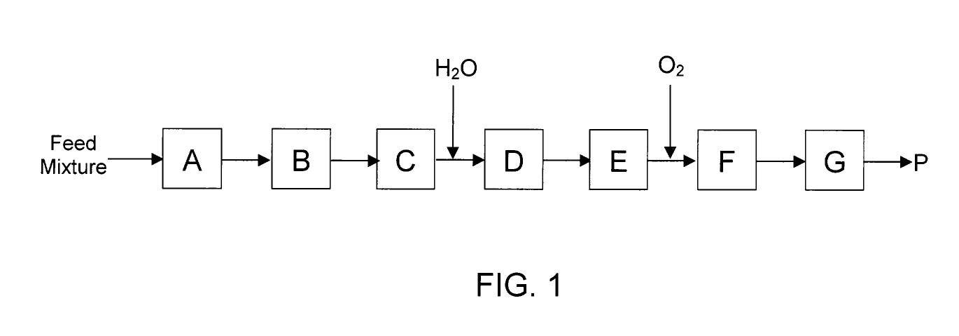

In general, each of the illustrative embodiments of the present invention includes one or more of the following process steps. FIG. 1 depicts a general process flow diagram illustrating the process steps included in the illustrative embodiments of the present invention. One of skill in the art should appreciate that a certain amount of progressive order is needed in the flow of the reactants through the reactors disclosed herein.

Process step A is a reforming process in which two different reactions may be carried out. Formulas I and II are exemplary reaction formulas wherein methane is considered as the hydrocarbon:

CH₄+½O₂→2H₂+CO (I)

CH_{4+H}₂O→3H₂+CO (II)

The partial oxidation reaction (formula I) occurs very quickly to the complete conversion of oxygen added and is exothermic (i.e. produces heat). A higher concentration of oxygen in the feed stream favors the partial oxidation reaction.

The steam reforming reaction (formula II), occurs slower and is endothermic (i.e. consumes heat). A higher concentration of water vapor favors steam reforming.

One of skill in the art should understand and appreciate that partial oxidation and steam reforming may be combined to convert the feed stream F into a synthesis gas containing hydrogen and carbon monoxide. In such instances, the ratios of oxygen to hydrocarbon and water to hydrocarbon become characterizing parameters. These ratios affect the operating temperature and hydrogen yield.

The operating temperature of the reforming step can range from about 550° C. to about 900° C., depending on the feed conditions and the catalyst. The invention uses a catalyst bed that may be in any form including pellets, spheres, extrudate, monoliths, and the like or wash coated onto the surface of fins or heat pipes as described herein.

Partial oxidation catalysts should be well known to those with skill in the art and are often comprised of noble metals such as platinum, palladium, rhodium, and/or ruthenium on an alumina washcoat on a monolith, extrudate, pellet or other support. Non-noble metals such as nickel or cobalt have been used. Other washcoats such as titania, zirconia, silica, and magnesia have been cited in the literature. Many additional materials such as lanthanum, cerium, and potassium have been cited in the literature as “promoters” that improve the performance of the partial oxidation catalyst.

Steam reforming catalysts should be known to those with skill in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium.

When Step A is primarily an autothermal reforming process, process step B is a cooling step for cooling the synthesis gas stream from process step A to a temperature of from about 600° C. to about 200° C., preferably from about 500° C. to about 300° C., and more preferably from about 425° C. to about 375° C., to optimize the temperature of the synthesis gas effluent for the next step. This cooling may be achieved with heat sinks, heat pipes or heat exchangers depending upon the design specifications and the need to recover/recycle the heat content of the gas stream. In one illustrative embodiment, the condensing end of a heat pipe, utilizes the feed stream as a heat sink as the feed stream flows into the reactor, thereby preheating the feed stream and cooling the reaction product gas. The heat pipe can be of any suitable construction known to those with skill in the art as is discussed in greater detail below. Alternatively, or in addition thereto, cooling step B may be accomplished by injecting additional feed components such as fuel, air or water. Water is preferred because of its ability to absorb a large amount of heat as it is vaporized to steam. The amounts of added components depend upon the degree of cooling desired and are readily determined by those with skill in the art.

When Step A is primarily a steam reforming process, process step B is optional because of the endothermic nature of the steam reforming process. In such instances heat is provided to the steam reforming process by way of a heat pipe that has the condensation end integrated into the catalyst bed. That is to say, in such an illustrative embodiment, the catalyst bed serves as the heat sink for the heat pipe. The heat source in such an illustrative embodiment may be an anode tail gas oxidizer or the partial oxidation reactor disclosed below as Step G.

Process step C is a purifying step. One of the main impurities of the hydrocarbon stream is sulfur, which is converted by the reforming step A to hydrogen sulfide. The processing core used in process step C preferably includes zinc oxide and/or other material capable of absorbing and converting hydrogen sulfide, and may include a support (e.g., monolith, extrudate, pellet etc.). Desulfurization is accomplished by converting the hydrogen sulfide to water in accordance with the following reaction formula III:

H₂S+ZnO→H₂O+ZnS (III)

Other impurities such as chlorides can also be removed. The reaction is preferably carried out at a temperature of from about 300° C. to about 500° C., and more preferably from about 375° C. to about 425° C. Zinc oxide is an effective hydrogen sulfide absorbent over a wide range of temperatures from about 25° C. to about 700° C. and affords great flexibility for optimizing the sequence of processing steps by appropriate selection of operating temperature. As was the case with the prior step, the temperature of the reaction can be regulated by use of heat pipes as will be apparent to one of skill in the art.

The effluent stream may then be sent to an optional mixing step D in which water is added to the gas stream. The addition of water lowers the temperature of the reactant stream as it vaporizes and supplies more water for the water gas shift reaction of process step E (discussed below). The water vapor and other effluent stream components can mixed by being passed through a processing core of inert materials such as ceramic beads or other similar materials that effectively mix and/or assist in the vaporization of the water. Alternatively, any additional water can be introduced with feed, and the mixing step can be repositioned to provide better mixing of the oxidant gas in the CO oxidation step G disclosed below.

Process step E is a water gas shift reaction that converts carbon monoxide to carbon dioxide in accordance with formula IV:

H₂O+CO→H₂+CO₂ (IV)

In this is process step, carbon monoxide, a poison to fuel cells, is substantially removed from the gas stream and is converted into carbon dioxed, which is generally considered an inert gas in fuel cells. The concentration of carbon monoxide should preferably be lowered to a level that can be tolerated by fuel cells, typically below 50 ppm. Generally, the water gas shift reaction can take place at temperatures of from 150° C. to 600° C. depending on the catalyst used. Under such conditions, most of the carbon monoxide in the gas stream is oxidized to carbon dioxide.

Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like.

High temperature shift catalysts are preferably operated at temperatures ranging from about 300° to about 600° C. and can include transition metal oxides such as ferric oxide or chromic oxide, and optionally including a promoter such as copper or iron silicide. Also included, as high temperature shift catalysts are supported noble metals such as supported platinum, palladium and/or other platinum group members.

The processing core utilized to carry out this step can include a packed bed of high temperature or low temperature shift catalyst such as described above, or a combination of both high temperature and low temperature shift catalysts. The process should be operated at any temperature suitable for the water gas shift reaction, preferably at a temperature of from 150° C,. to about 400° C. depending on the type of catalyst used. Optionally, an element such as a heat pipe may be disposed in the processing core of the shift reactor to control the reaction temperature within the packed bed of catalyst. In such an illustrative embodiment, the high temperature shift reaction is first carried out followed by the low temperature shift reaction. Control over the reaction temperatures is favorable to the conversion of carbon monoxide to carbon dioxide. Also, a purification processing, such as a desulfurization reaction such as step C, can be performed between high and low shift conversions by providing separate steps for high temperature and low temperature shift with a desulfurization module between the high and low temperature shift steps.

Process step F is a cooling step performed in one embodiment by a heat pipe. The heat pipe can be of any suitable construction as is described below. The goal of the heat pipe is to reduce the temperature of the gas stream to produce an effluent having a temperature preferably in the range of from about 90° C. to about 150° C.

Oxygen is added to the process in step F. The oxygen is consumed by the reactions of process step G described below. The oxygen can be in the form of air, enriched air, or substantially pure oxygen. A heat pipe may be utilized in this step to regulate the temperature of the gas and be designed with baffles, fins of other turbulence inducing structures to provide mixing of the oxygen with the hydrogen rich gas.

Process step G is an oxidation step wherein remaining carbon monoxide in the effluent stream is substantially converted to carbon dioxide. Two reactions occur in process step G: the desired oxidation of carbon monoxide (formula V) and the undesired oxidation of hydrogen (formula VI) as follows:

CO+½O₂→CO₂ (V)

H₂+½O₂→H₂O (VI)

The processing is carried out in the presence of a catalyst for the oxidation of carbon monoxide and may be in any suitable form, such as pellets, spheres, monolith, etc. Oxidation catalysts for carbon monoxide are known and typically include noble metals (e.g., platinum, palladium) and/or transition metals (e.g., iron, chromium, manganese), and/or compounds of noble or transition metals, particularly oxides. A preferred oxidation catalyst is platinum on an alumina washcoat. The washcoat may be applied to a monolith, extrudate, pellet or other support. Additional materials such as cerium or lanthanum may be added to improve performance. Many other formulations have been cited in the literature with some practitioners claiming superior performance from rhodium on alumina catalysts. Ruthenium, palladium, gold, and other materials have been cited in the literature as being active for this use.

The preferential oxidation of carbon monoxide is favored by low temperatures. Because both reactions produce heat, a heat pipe can be disposed within the reactor to remove heat generated in the process. The operating temperature of process is preferably kept in the range of from about 90° C. to about 150° C. Thus, one of skill in the art should appreciate that this step can serve as a substantial heat source and thus integrated using a suitable heat pipe with other process steps that are endothermic, for instance steam reforming in Step A.

Process step G preferably reduces the carbon monoxide level to less than 50 ppm, which is a suitable level for use in fuel cells, but one of skill in the art should appreciate that the present invention can be adapted to produce a hydrogen rich product with of higher and lower levels of carbon monoxide.

The effluent P exiting the fuel processor is a hydrogen rich gas containing carbon dioxide and other constituents which may be present such as water, inert components (e.g., nitrogen, argon), residual hydrocarbon, etc. Product gas may be used as the feed for a fuel cell or for other applications where a hydrogen rich feed stream is desired. Optionally, product gas may be sent on to further processing, for example, to remove the carbon dioxide, water or other components.

Having described the generic process, one of skill in the art should appreciate and understand that a major challenge to the financial viability of a fuel processor is low cost heat management. The challenges to overcome include: the controlling temperatures of reaction in the catalyst beds; fast addition heat into the beds for quick start-up; removing heat in a manner to maintain isothermal bed temperatures; commercial production of the fuel processor at an economically viable cost; as well as other challenges which should be well known to one of skill in the art.

Heat pipes are devices used to rapidly move heat and maintain temperatures to precise settings. In the temperature ranges of the zinc oxide (Step C), water gas shift (Step E) and partial oxidation (Step G) catalyst beds of a fuel processor, a simple, inexpensive copper/water heat pipe could be used. When temperatures are above 500° C., such as at the outlet of the autothermal reformation catalyst (Step A), the high temperatures require use of other materials, such as stainless steel/sodium heat pipes.

One of skill in the art should understand and appreciate that heat pipes, also known as thermo-siphons are devices widely used to transfer high rates of heat flow with negligible temperature drop, i.e., a device with inherent ultra high thermal conductance. A wide variety of differing heat pipes have been disclosed in the literature and should be known to one of skill in the art. Selection of a suitable heat pipe will depend upon several factors including: whether the reaction being regulated is to serve as a heat sink or as a heat source; the desired temperature ranges; the tolerance for variations in temperature acceptable to the reaction; efficiency; cost; and, other factors that should be apparent to those of skill in the art. To assist such a skilled artisan, the following description of several different heat pipes is provided below. However, it should be understood that many types of heat pipes exist and may be utilized within the scope of the present invention.

Turning now with reference to FIG. 2, a heat pipe 210, in its simplest and most common “generic” form, also referred to as “constant conductance heat pipes” includes a closed pressure vessel 212, in a general pipe shape, containing a working fluid 214 (liquid and vapor) in saturated thermal equilibrium. External heat is input to an evaporator section 216, and heat is rejected to an external heat sink (not shown) from a condenser section 218. The evaporator section 216 and condenser section 218 are connected by a vapor flow volume and an internal capillary wick 222. A working fluid 214, such as ammonia or water or other fluid, absorbs its phase-change “heat of vaporization” as it evaporates in the evaporator section 216, flows to the condenser section 218, as shown by dashed arrows 221, and condenses, giving up that heat to the heat pipe 212 walls. The working fluid then returns in liquid form to the evaporator section 16 via capillary pumping within the wick 222. One useful heat pipe material is aluminum because it is readily-extruded so as to have integral wicks of fine channels in the wall. However, heat pipes can be made of other metals including copper and stainless steel.

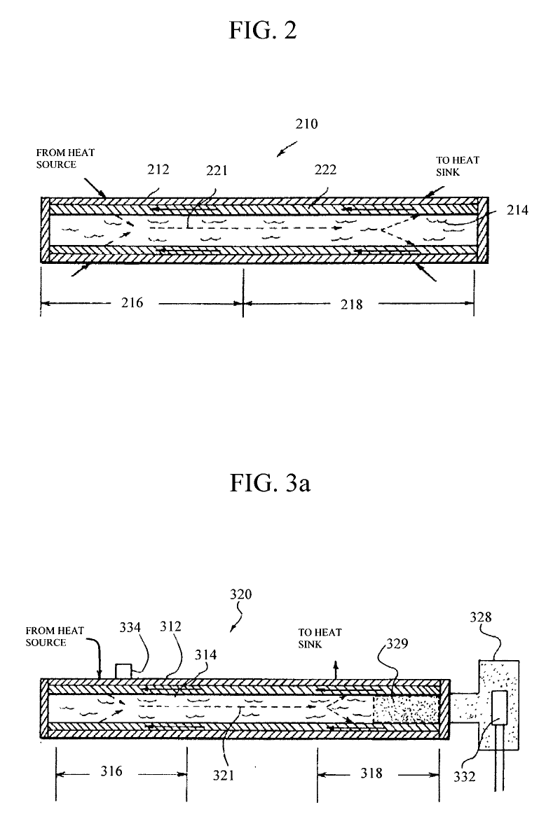

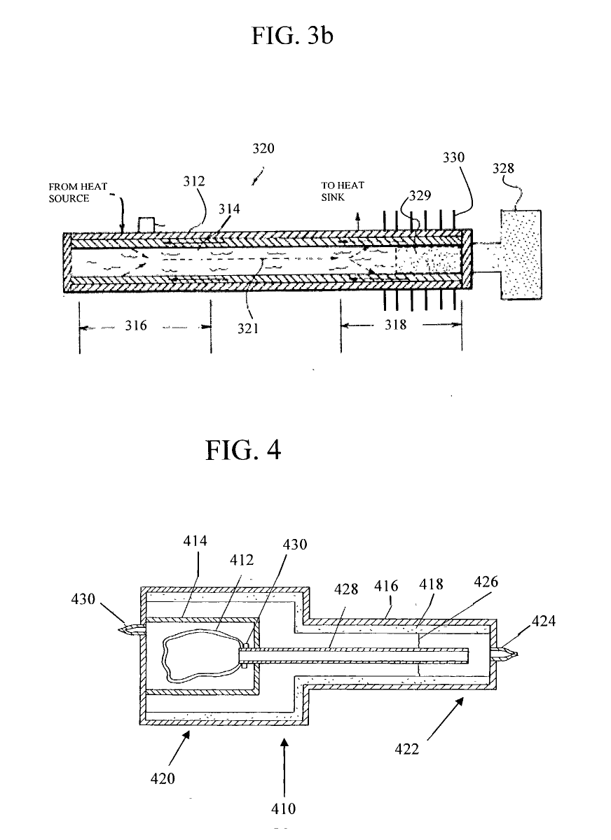

The generic heat pipe described above is passive; i.e., Its conductance is essentially constant, with no features to modulate conductance to “actively” control temperature. Other forms of the heat pipe have features that provide active temperature control or diode action examples of which are shown in FIG. 3a and FIG. 3b. One form of an “active control” heat pipe 320, is termed a “variable conductance heat pipe”. The variable conductance heat pipe relies on a contained volume of non-condensing gas 329 to displace a controlled portion of the working fluid 314 in the condenser 318, rendering that portion of the condenser 318 containing the working fluid 314 thermally inactive. The non-condensing gas is stored in a reservoir 328, (i.e. a non-condensing gas reservoir) connected to the condenser-end, and is partially displaced from the reservoir 328 into the condenser 318. As shown in FIG. 3a this occurs when heated by an electrical heater 332 on the reservoir 328 wall. As shown in FIG. 3b, this occurs by controlling the heat dissipated by fins 330 to a cooling fluid (not shown) such as air or a cooling fluid. The volume of the non-condensing gas is a function primarily of the reservoir 328 temperature. In FIG. 3a the volume is controlled by a thermostat, or temperature sensor 334, on the evaporator 316 controls the non-condensing gas reservoir heater 332 operation and thus the evaporator 316 temperature. In FIG. 3b the volume is controlled by controlling the flow and temperature of a cooling fluid (not shown) over the cooling fins 330. Variable conductance heat pipe 320 work quite well, are reliable and predictable. The non-condensing gas reservoir 328 volume is proportional to variable conductance heat pipe 320 condenser 318 length; thus condenser 318 length is usually limited by volume, mass, and heater 332 power restrictions associated with the non-condensing gas reservoir 328, and not defined by actual condenser 318 length requirements based on required radiator area.

Some variable conductance heat pipes 320, such as those shown in FIGS. 3a and 3b, operate very efficiently in maintaining an isothermal condition for the evaporator. For example the variable conductance heat pipe condenser 318 is capable of a full 0 to 100% effectiveness range corresponding to a narrow evaporator temperature band, on the order of 1° or 2° C.

A self-regulating variable conductance heat pipe is disclosed in U.S. Pat. No. 4,799,537, the contents of which are incorporated herein by reference. As described therein a self-regulating heat pipe includes a sealed hollow casing; a quantity of vaporizable heat transfer fluid within the casing; a quantity of non-condensable gas within the casing; an expandable primary reservoir volume with an opening, the primary reservoir being located within the casing in a evaporator region of the casing to which heat is applied and acted upon by a force means which resists the expansion of the primary reservoir volume, wherein the force means is a secondary reservoir filled with a non-condensable gas, with the primary reservoir volume enclosed within the secondary reservoir; and conduit means with one end attached to the opening of the primary reservoir, and the other end opening into a condenser region of the heat pipe from which heat is removed. Turning to FIG. 4, illustrated is a simplified cross section view along the axis of a self-regulating heat pipe of the type described in U.S. Pat. No. 4,799,537 in which the heat pipe 410 encloses non-condensable gas primary reservoir 412 and secondary reservoir 414.

Heat pipe 410 is conventionally constructed of sealed casing 416 with capillary wick 418 lining the inner walls of casing 416. In operation, one end of heat pipe 410 is the evaporator region 420 to which heat is applied and the other end is the condenser region 422 from which heat is removed. If heat pipe 410 were evacuated and only vaporizable working fluid were loaded into it at fill tube 424, it would operate as a conventional heat pipe.

However, when a non-condensable gas such as nitrogen is also loaded into heat pipe 410, it operates somewhat differently. As is well understood in the art, the noncondensable gas will be swept to condenser region 422 of the heat pipe 410 by the movement of the working fluid vapor and the gas will collect there, preventing that part of the heat pipe which it occupies from operating as a heat pipe. In fact, a boundary 426 will form between the volume of the heat pipe which contains non-condensable gas and that volume which does not.

A secondary reservoir 414, which has a non-expandable structure, is located in evaporator region 420. It encloses primary reservoir 412 the opening of which is attached to conduit 428 and held in place by clamp 430. The end of conduit 428 which is remote from primary reservoir 414 opens into the interior of heat pipe 410 near the end of condenser region 422 which is most remote from evaporator region 420. The open end of conduit 428 is located well into the region of the heat pipe, which contains the non-condensable gas. During normal operation the non-condensable gas will, therefore, fill conduit 428 and partially inflate expandable primary reservoir 412. This expansion will be resisted and limited by the pressure of the non-condensable gas which has been loaded into secondary reservoir 414 through its fill tube 432.

The pressure of the gas in secondary reservoir 414 determines the heat pipe's temperature control point, and that pressure is one of the design parameters. The pressure of the gas in secondary reservoir 414 should be the same as the vapor pressure of the heat transfer fluid in the heat pipe at the nominal operating temperature.

With the pressure of the gas in secondary reservoir 414 determined, pressure equilibrium will be established between secondary reservoir 414 and the gas and vapor mixture in expandable primary reservoir 412, and boundary 426 will locate where it forces the working fluid vapor pressure and the pressure of the mixture of vapor and non-condensable gas to also be equal.

The automatic control phenomenon is disclosed as functioning as follows. If conditions attempt to raise the temperature of evaporator region 420, the vapor pressure of the heat transfer fluid will attempt to rise. This will push boundary 426 farther away from evaporator region 420 and thereby activate more surface of heat pipe 410 within condenser region 422 to afford more cooling to limit the temperature rise at evaporator 420.

The movement of boundary 426 meets only slight resistance because it is accommodated to by the expansion of primary reservoir 412, which is, in effect, at the opposite end of the combined gas vapor zone from boundary 426. The expansion of primary reservoir 412 itself meets with little resistance because its movement is resisted only by the gas pressure in secondary reservoir 414, which is, as mentioned, nominally the same as the vapor pressure of the heat transfer fluid. The increased volume of primary reservoir 412 therefore limits the temperature increase of evaporator region 420, and a decrease in volume of primary reservoir 412 will also occur to limit a decrease in temperature of evaporator region 420.

This feedback system is aided by the fact that the non-condensable gases in secondary reservoir 414 and in primary reservoir 412 are essentially at the temperature of evaporator region 420 and are therefore at a constant temperature, thus eliminating any temperature change effects on pressure. Moreover, since the temperature of the gases is approximately that of the highest temperature in the system, no condensation of vapor will occur in expandable primary reservoir 412.

Self-regulating heat pipes of the type described above have been tested in a heat pipe constructed of copper, with water as the working fluid, and having an expandable primary reservoir constructed of aluminized plastic film, such as MYLAR™. The disclosed embodiment is reported to have exhibited superior self regulating properties in that, with a change in heat sink temperature over the range from negative 0.23° C. to positive 29.4° C., the heat pipe evaporator temperature varied only 1.15° C. from the set point temperature of 36.1° C. On the other hand a more conventional heat pipe with a fixed wall non-condensable gas reservoir could be expected to have a variation in evaporator temperature approximately four times as great.

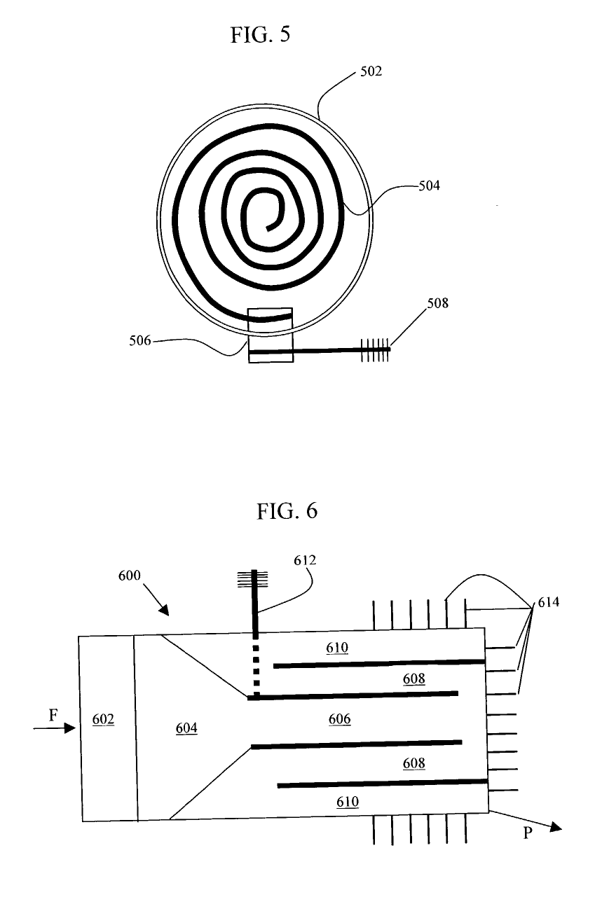

One illustrative embodiment of the present invention is shown in FIG. 5 as a top cross-sectional view of a reaction chamber 502 in which a helically shaped heat pipe 504 has been placed. The helical shape of the heat pipe permits the addition of catalyst (not shown) such that there is thermal transfer from the catalyst to the helical heat pipe. In order to ensure the integrity of the reactor, a heat transfer block 506 is utilized. The reactor end of the heat transfer block is in thermal communication with the helical heat pipe. The exterior side of the heat transfer block is in thermal communication with a second heat pipe 508 that dissipates the heat of the heat transfer block. As shown the condenser end of the second heat pipe has heat dissipating fins.

Another illustrative embodiment of the present invention is shown in FIG. 6 which shows a compact fuel processor 600 in a schematic cross-sectional view. As shown, an anode tail gas oxidizer 602 preheats the feed gas (F) and is utilized as a primary heat source for the reformer section 604 (Step A). The reformer section may be designed to be an autothermal reformer, however, because of the close proximity of the anode tail gas oxidizer, it is preferred that the reformer section is a steam reformer. The hydrogen containing gas from the reformer section 604 passes into the hydrogen sulfide/zinc oxide reactor (Step C) and is cooled by a surrounding heat pipe 612. The hydrogen containing gas then proceeds into the water gas shift reaction section 608 (Step E) where the CO content is substantially decreased. The hydrogen containing gas proceeds into the partial oxidation reactor 610 (Step G) which is cooled by heat pipes or heat fins 614. The product hydrogen rich gas P exits the reformer and is ready to be utilized, preferably in a fuel cell.

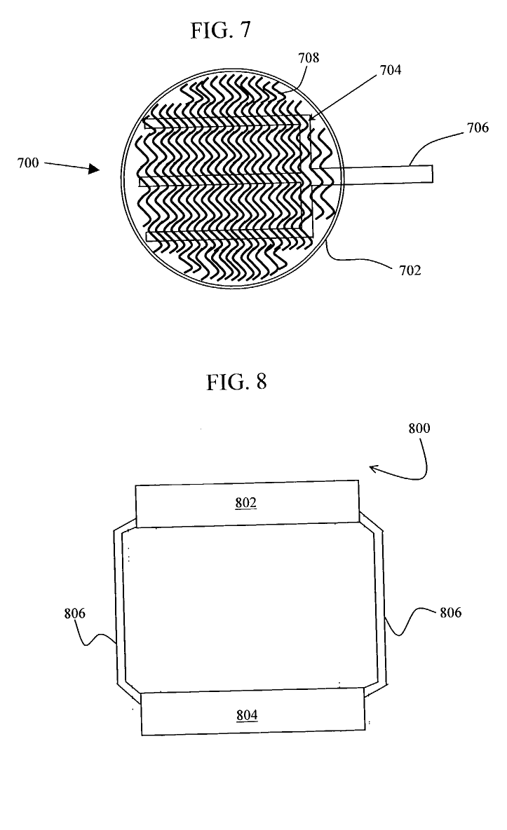

A third illustrative embodiment of the present invention is shown in FIG. 7. Shown in a top, cross-sectional view is a heat pipe utilized in the place of traditional fluid based heat exchanger of a compact fuel processor 700, such as those disclosed in published U.S. patent applications Ser. Nos. 2002/0083646 A1; 2002/0094310 A1; 2002/0098129 A1; 2002/0090334 A1; 2002/0090326 A1; 2002/0088740 A1; 2002/0090327 A1; 2002/0090328 A1 all of the contents of which are incorporated herein by reference. Turning to FIG. 7, a reactor 702 has a heat pipe (704 and 706) which has an evaporative end 704 and a condensing end 706. As shown the evaporative end 704 (i.e. heat source) of the heat pipe is contained within the reactor and the condensing end 706 (heat sink) is exterior to the reactor. One of skill in the art should appreciate and understand that the two ends can be interchanged such that the interior of the reactor is the heat sink. Such would be the case for a reactor in which an endothermic reaction, such as steam reforming, is to be carried out. Thermal fins 708 have the dual functional role of supporting the catalyst and also facilitating the transfer of heat. In one illustrative embodiment, the heat pipe is used to preheat the feed gas prior to entry into the steam reformer. One of skill in the art should also appreciate that the condenser section 704 of the illustrated heat pipe may be connected to a similarly shaped fined heat pipe in another section of the fuel reformer as is shown in FIG. 8. As is shown in a cross-sectional side view, a fuel reformer 800, encloses both the condensing section 802 and the evaporative section 804 of a heat pipe. The two section will be connected together by one or more thermal conduits 806 or secondary heat pipes.

One of ordinary skill in the art should also appreciate that the inventors contemplate that the outer surfaces and/or fins of the heat pipes may be coated with catalyst and/or catalyst particles. It has been reported that the fins could be coated with a ceramic catalyst relatively simply. The idea shown in FIG. 7 would be to coat the fins with catalyst with the heat pipe passing through the fins. This could be used to cool exothermic reactions as well as heat catalyst beds that require external heat to produce a reaction, such as steam reforming. The coating process likely will involve the wash coating of fine particulate catalyst onto the surface of the fins once the heat pipe has been made. The idea is to maximize the surface area of reaction and heat exchange as much as possible on the heat pipe by placing a finned extrusion over the heat pipe and coating the fins with catalyst. Although shown in FIG. 7 as being a “forked shaped” heat pipe, it is contemplated that the heat pipe may be helical as is shown in FIG. 5. Other similar variations to increase the surface area of the heat pipes should be apparent to one of ordinary skill in the art.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention.

What is claimed is:

1. An apparatus for converting hydrocarbon fuel into a hydrogen rich gas comprising:
a hydrocarbon reforming reactor including a catalyst for reacting a fuel mixture under reforming conditions to give a hydrogen containing gaseous mixture;
a water gas shift reactor including a catalyst for reacting the hydrogen containing gaseous mixture under water gas shift reaction conditions to give an intermediate hydrogen containing gaseous mixture with a substantially reduced carbon monoxide content; and
a selective oxidation reactor including a catalyst for reacting the intermediate hydrogen containing gaseous mixture under selective oxidation reaction conditions to produce the hydrogen rich gas
wherein the temperatures of the reactor beds are regulated by the use of heat pipes.

2. The apparatus according to claim 1, further comprising a heat pipe for transmitting the heat generated in the selective oxidation reactor to pre-heat the hydrocarbon fuel into a heated hydrocarbon fuel, wherein the heated hydrocarbon fuel becomes the hydrocarbon fuel feed to the hydrocarbon reforming reactor.

3. The apparatus according to claim 1, wherein the reforming reaction is steam reforming and wherein the reforming reaction serves as a heat sink for a heat pipe.

4. The apparatus according to claim 3, wherein the heat source for the reforming reaction heat pipe is an anode tail gas oxidizer for a fuel cell.

5. The apparatus according to claim 1, wherein the heat pipe is selected from a simple heat pipe; variable conductance heat pipe or a self-regulating variable conductance heat pipe.

6. The apparatus according to claim 1, wherein the heat pipe is a self-regulating variable conductance heat pipe.

7. The apparatus according to claim 1, wherein the heat pipe is a copper/water heat pipe.

8. The apparatus according to claim 1, wherein the heat pipe is a stainless steel/sodium heat pipe.

9. The apparatus according to claim 1, further comprising a desulfurization reactor including a catalyst for reacting the hydrogen containing gaseous mixture under desulfurization conditions to produce a substantially desulfurized hydrogen containing gaseous mixture, wherein the substantially desulfurized hydrogen containing gaseous mixture becomes the hydrogen containing gaseous mixture feed to the water gas shift reactor.

10. The apparatus according to claim 1, wherein the hydrocarbon fuel is selected from the group consisting of natural gas, methane, ethane, propane, butane, liquefied petroleum gas, naphtha, gasoline, kerosene, diesel, methanol, ethanol, propanol, and combinations thereof.

11. The apparatus according to claim 1, wherein the hydrogen rich gas contains less than 50 ppm of carbon monoxide.

12. The apparatus according to claim 1, further comprising an anode tail gas oxidizer including a catalyst for reacting the unconverted hydrogen from a fuel cell under oxidation conditions to create a hot anode tail gas oxidizer effluent.

13. The apparatus according to claim 12, wherein the hot anode tail gas oxidizer effluent is heat integrated with the hydrocarbon reforming reactor utilizing a heat pipe.

14. The apparatus according to claim 1, wherein the heat pipe maintains an isothermal bed temperatures within at least one of the reactors.
